(19) United States
(12) Patent Application Publication
(10) Pub. No.: US 2025/0167508 A1
(43) Pub. Date: May 22, 2025

(54) LASER ARRANGEMENT AND METHOD FOR STARTUP

(71) Applicant: CRYLAS CRYSTAL LASER SYSTEMS GMBH, Berlin (DE)

(72) Inventors: Alexander Gluth, Berlin (DE); Martin Tittel, Berlin (DE); Eckhard Zanger, Seddiner See (DE)

(21) Appl. No.: 18/841,336

(22) PCT Filed: Jan. 25, 2023
(86) PCT No.: PCT/EP2023/051774

§ 371 Date: Aug. 23, 2024

(30) Foreign Application Priority Data
Feb. 24, 2022 (DE) 10 2022 104 383.5

(51) Int. Cl. H01S 3/139

(52) U.S. Cl. CPC H01S 3/1396

(57) ABSTRACT

It is provided a laser arrangement for generating laser light, comprising a laser resonator for initial oscillation of two laser modes between a first and a second resonator mirror which are spaced apart from one another by a resonator length. The second resonator mirror can be configured and provided for coupling the two laser modes out of the laser resonator and has a first frequency-dependent attenuation profile for laser light. The laser arrangement further comprises a laser medium which is arranged between the resonator mirrors, a measuring device which is configured and provided for measuring at least one parameter of the two out-coupled laser modes and/or at least one ambient condition of the laser arrangement, and a control device which is configured and provided for adjusting the resonator length and the first attenuation profile on the basis of the at least one parameter and/or the at least one ambient condition.

### BACKGROUND

The disclosure relates to a laser arrangement for generating laser light, and a method for starting up a laser arrangement.

A laser arrangement of this kind can be used for industrial applications, in particular diode-pumped and having external resonant frequency doubling. In industrial applications, wavelengths in the ultraviolet range are particularly in demand, in particular in the semiconductor industry. Frequently, solid-state lasers are used, which generate wavelengths in the red or infrared spectral range. The wavelengths of the solid-state laser can be frequency-converted, in order to generate the desired wavelength in the ultraviolet range. Nonlinear crystals can be used for the conversion.

The frequency conversion can take place inside or outside a laser resonator.

A frequency conversion in the laser resonator (“intracavity frequency conversion”) can have the disadvantage that nonlinear coupling of a plurality of laser modes in the nonlinear crystal can result in significant amplitude noise (“Green Problem”; see e.g. T. Bear, J. Opt. Soc. Am. B, vol. 3, no. 9, September 1986, pp. 1175-1180).

A plurality of methods are known for avoiding the green problem. For example, a length of the laser resonator can be selected to be so large that a particularly large number of longitudinal laser modes are excited in the resonator (see U.S. Pat. No. 5,638,388). Another method is to provide operation having a single laser mode, as a result of which coupling of a plurality of laser modes is necessarily excluded, such as in the case of a ring laser, twisted mode laser, or microchip laser.

The two methods mentioned above require complex laser arrangements which are fragile and result in significant complexity during operation. Furthermore, frequency-sensitive elements may be required in the laser resonator, which limit the achievable power to unattractively low values.

In a further method, a laser resonator is configured such that exactly two laser modes, in particular longitudinal modes, of neighboring frequencies, are excited. In these methods, the frequency conversion can be performed outside of the laser resonator. An external resonator may be provided for the conversion outside of the laser resonator. A nonlinear coupling of the laser modes within the laser resonator can the no longer take place. An operation comprising two longitudinal modes is described for example in the publications C. Zimmermann et al, “Design for a compact tunable Ti:Sapphire Laser”, Optics Letters, vol. 20, no. 3, 1995, pages 297-299, and A. Hohla et al., “Bichromatic frequency conversion in potassium niobate”, Optics Letters, vol. 23, no. 6, 1998, pages 436-438.

DE 10 339 210 B4 describes a laser arrangement for generating laser light having two laser modes.

The object of the present invention is that of providing a laser arrangement which allows for more stable operation.

### SUMMARY

The object is achieved according to a first aspect of the solution by a laser arrangement having features as described herein.

A laser arrangement of this kind comprises a laser resonator for initial oscillation of two laser modes between a first and a second resonator mirror. The resonator mirrors are spaced apart from one another by a resonator length, wherein the second resonator mirror is configured and provided for coupling the two laser modes out of the laser resonator. The second resonator mirror has a first frequency-dependent attenuation profile for laser light. The second resonator mirror can be configured as an outcoupling mirror. It can serve as a frequency-selective element.

The laser resonator may be a linear resonator. In a linear resonator, standing waves form which lead to zones of high field strength (antinodes of oscillation) and zones of low field strength (nodes of oscillation). The population inversion in the laser medium is spatially modulated by the zones of different field strengths (“hole-burning effect”). When the laser medium is arranged in the optical center of the resonator, adjacent longitudinal modes are phase-shifted about 90°, such that these adjacent laser modes draw their energy from different zones. Figuratively speaking, a first laser mode has a node of oscillation at a zone in which a second laser mode neighboring the first has an antinode of oscillation. The initial oscillation of exactly two neighboring laser modes may be preferred, in order to prevent the “hole-burning” effect.

Such a configuration of exactly two laser modes leads on the one hand to an efficient use of the population inversion in the laser medium, and on the other hand the energy coupling of different laser modes in the resonator is prevented.

The second resonator mirror can ensure, by the frequency-selecting property, that two particular laser modes are particularly low-loss and therefore preferably oscillate initially.

The laser arrangement further comprises a laser medium which is arranged between the resonator mirrors. In particular, the laser medium can be arranged in an optical center between the resonator mirrors. The laser medium can for example comprise an Nd:YVO4 crystal.

By using the exactly three optical elements of resonator mirrors and laser medium, the resonator can be implemented in a particularly compact and mechanically stable manner.

Outside influences can in particular interfere with the operation with exactly two longitudinal modes. However, for low-noise operation it is desirable for exactly two longitudinal modes (and not more) to be active in the laser resonator.

As soon as a third laser mode is added, for example when using an external resonator by “mode beating”, and likewise by dispersion in the laser resonator, noise frequencies in the MHz range may occur, which are undesired in applications in particular in the semiconductor industry. A third laser mode can be brought about by changes to the ambient conditions, such as temperature and air pressure, as well as long-term effects such as mechanical relaxation, thermal misalignment, and aging of materials. Such conditions and effects can have an impact on a geometry, in particular length, of the laser resonator, and thus on the mode spectrum. For example, resonant frequencies of the laser resonator may shift relative to frequencies for which the second resonator mirror is configured and provided, when the resonator length, in particular the optical length, changes. Three modes can then start to oscillate simultaneously. When three modes are active, difference frequencies of the mode spacings may occur in the frequency-converted laser beam, which differ slightly by the dispersion in the laser resonator. These difference frequencies are in the range of a few MHz. It is therefore desirable to keep the resonator length as constant as possible.

The laser arrangement further comprises a measuring device which is configured and provided for measuring at least one parameter of the at least one out-coupled laser mode and/or an ambient condition of the laser arrangement.

Furthermore, the laser arrangement comprises a control device which is configured and provided for adjusting the resonator length and the first attenuation profile on the basis of the at least one parameter and/or the at least one ambient condition.

The control device can then for example comprise (electronic) regulation for controlling an optical length of the laser resonator and of the first attenuation profile. The measuring device can be configured for generating a power signal which is dependent on a power of the two laser modes and which serves as an input signal for the regulation. The regulation can be directed to maintaining a low-noise, stable two-mode operation.

Outside influences such as ambient condition and long-term effects can be compensated using the control device, in order to ensure a lasting low-noise operation, in particular with exactly two laser modes. In the compensation, use can be made of the fact that a power of a frequency-converted radiation generated from exactly two outcoupled laser modes assumes a maximum when the two laser modes in the laser resonator have the same intensity. The frequency-converted radiation can be generated in an external resonator.

The measuring device can comprise a photodetector, by means of which the converted power P can be detected. The photodetector can for example deliver an electronic input signal for the regulation of the control device. The control device can change the resonator length via a temperature Tᵣ of the laser resonator such that the converted power P is as high as possible. A maximum power can be equivalent to an operation with exactly two laser modes in the case of symmetrical distribution of the power over the two laser modes.

The laser medium has a second frequency-dependent attenuation profile, and the control device is configured and provided to change the first and the second attenuation profile, in particular to adjust them to one another. In particular, the second attenuation profile can be changed independently of the laser resonator and of the second resonator mirror.

As a result, for example undesired long-term effects can be reduced by mechanical relaxation or thermal misalignment, which necessarily results during operation of the laser arrangement. Mechanical relaxation can result from creep deformation of materials under load, such as metal parts, from which the laser resonator is constructed. Thermal misalignment can result due to different expansion coefficients in the connection of different materials. In the case of temperature changes which can occur in the case of switching laser systems on and off, the different expansion coefficients can lead to a relative movement which may be irreversible on account of changing coefficients of friction. Repeated processes of switching on and off can therefore lead to progressing misalignment of the laser system, which can be expressed inter alia in the formation of undesired additional laser modes and thus additional noises.

A laser arrangement according to the solution can counteract this and, by the controlled changing of the attenuation profiles, allow for problem-free operation over 20,000 hours, such that for example outages during semiconductor production can be prevented.

In one embodiment, the laser resonator and the second resonator mirror are configured and provided such that exactly two laser modes, in particular longitudinal modes, of neighboring frequencies can be outcoupled. During operation of the laser arrangement as a two-mode laser, the outlay for obtaining the two laser modes in a low-noise and frequency-converted manner is substantially lower than is the case for example for a single-mode laser, in which only exactly one laser mode is provided.

In one embodiment, the laser arrangement comprises at least one external, in particular passive, resonator which is configured and provided for receiving the two laser modes from the laser resonator and for converting the frequency of the two laser modes. For the conversion, the at least one external resonator can comprise a nonlinear crystal. In the conversion of the frequency, the frequency of the two laser modes can be shifted. For example, the frequency can be increased from red or infrared into the ultraviolet range. The conversion can take place in a stepwise manner, proceeding from the frequency of the two laser modes. For example, in a first step the frequency of the two laser modes can be converted for example from infrared, using a first external resonator, to a first frequency, for example in a green frequency range, and in a second step this can be converted, using a second external resonator, to a second frequency, for example ultraviolet.

In one embodiment, the measuring device is configured and provided for measuring the at least one parameter at the frequency-converted laser beam. The measuring device can in principle measure the at least one parameter at any desired point after the coupling of the two laser modes out of the laser resonator. Performing the measurement along a propagation direction of the laser beam after the at least one external resonator may inter alia have the advantage that the laser light ultimately provided by the laser arrangement can be measured.

In a first embodiment, the control device is configured and provided to adjust the first and the second attenuation profile to the effect that the frequencies of the minima of the attenuation profiles correspond. The attenuation profiles can describe how significantly a particular laser light frequency is attenuated by the laser medium or the second resonator mirror. In principle, a strength of the attenuation oscillates depending on the frequency, such that there are attenuation maxima and minima. The changing of the attenuation profiles can comprise adjusting of the attenuation profiles. The changing can in principle be used in order to for example shift the minima of the attenuation profiles relative to one another. Preferably, each of the attenuation profiles is changed such that in each case a minimum of the attenuation profiles corresponds to a minimum of the other attenuation profile in each case (i.e. is arranged at the same frequency).

In one embodiment, the laser medium comprises two parallel surfaces which are provided with a partially reflective (PR) coating in each case, and the normals of which are arranged at an angle between 1° and 6° obliquely to a propagation direction of the two laser modes. A reflectivity of the coating can in each case be between 0.2% and 2.0%, in particular between 0.4% and 0.8%, very particularly between 0.5% and 0.7%. A surface normal of the two parallel surfaces can enclose, with the propagation direction of the two laser modes, an angle different from zero, in particular of 1° to 6°. Providing an (optical) coating of a predetermined reflectivity on two parallel (optical) surfaces of the laser medium, and tilting counter to the propagation direction, can produce the frequency-dependent second attenuation profile of the laser medium. In particular, the coating of the laser medium makes it possible to create a defined and adjustable (second) attenuation profile, as a result of which a stable two-mode operation can be maintained. This is because a laser medium that is coated and tilted in this way forms a desired and controllable effect as an etalon. A partially reflective coating can on the one hand keep losses in the laser resonator low, and on the other hand generate desired etalon effects. A suitable method for producing the coating is for example “ion beam sputtering” (IBS). Thus, a coating can be produced (also in the case of mass production), the reflectivity of which is reliably above 0.2%, in particular above 0.5%, wherein an accuracy of the reflectivity in the case of IBS can be in a tolerance range of 0.1%.

In general, the change in the moisture can lead to changes in the properties of optical elements, in particular a reflectivity of the coating. The change in the reflectivity of the coating can in turn have different effects on the losses of the different laser modes, and thus the intensity distribution over the laser modes.

An uncontrolled appearance or disappearance of etalon effects on the laser medium can be superimposed on a desired frequency-selective behavior of the second resonator mirror, and counteract this in an undesired manner. Due to the change in the relative humidity in the laser resonator, the reflectivity of the coating can change to such an extent that two-mode operation is no longer ensured, and inadmissible noise results.

Changes in the moisture of the surroundings can for example be caused by rinsing with purge gas. A relative humidity of the purge gas can change over time. The change can take place abruptly, if the gas flushing system is undergoing maintenance or is replaced by a new one, or can take place slowly, in that a performance of a drying system of the laser arrangement diminishes over time.

In a further embodiment, the coating is therefore configured and provided to provide a reflectivity that is independent of the ambient conditions, in particular a moisture content of a gas surrounding the coating. This makes it possible to ensure that the reflectivity is for example independent of changes of the surrounding air humidity. Such coatings can be created e.g. by means of the ion beam sputtering (IBS) method. They can be characterized in that they have a reduced surface roughness, in particular fewer depressions into which moisture can precipitate, compared with coatings produced by other methods (for example “e-beam”).

In one embodiment, the control device is configured and provided for setting a temperature of the laser resonator via a first actuator and/or for setting a temperature of the laser medium via a second actuator, in order to change the first and the second attenuation profile, in particular to match them to one another. Accordingly, in order to change the attenuation profile, the geometrical and/or optical properties of the laser resonator and/or of the laser medium can be changed. This can take place by heating or cooling. In order to improve the independent setting of the temperature, a thermally insulating element can be provided between the laser resonator and the laser medium. The element can form a non-metal barrier which interrupts a propagation path for heat between the laser resonator and the laser medium. In general, thermal bridges between the laser resonator and the laser medium can be prevented.

The first and the second actuator can comprise Peltier elements which can be thermally linked to a common heat sink.

In one embodiment, the laser medium comprises a doped laser crystal, the doping level of which is determined such that the ratio of an optical length of the resonator to an optical length of the laser medium is greater than or equal to ten. An accuracy with which the doping level is specified can be located within the limits of ±0.05% (inclusive). In the case of a significant variance of the doping level, the ratio of the optical length of the resonator to the optical length of the laser medium sometimes cannot be ensured, such that for example a tolerance range for a two-mode operation of the laser arrangement is too narrow. Furthermore, a greater variance can lead to a high self-absorption and thus to low output power.

An embodiment of the laser medium as an etalon, and the more precise specification of the doping level, can have an average tolerance range of a temperature of the laser resonator at values of greater than or equal to 1 K, as a result of which the stability of the two-mode operation can be significantly increased. In principle, the temperature range of the resonator in which the two-mode operation is present can be at least 0.5 K.

In one embodiment, the at least one parameter includes a noise and/or a power of the converted laser beam. For example, the measuring device can measure a first parameter that relates to the noise of the converted laser beam, and/or can measure a second parameter that relates to the power. The noise can in particular be an (optical) amplitude noise. The measuring device can comprise a noise detector for measuring the noise. The noise can be measured up to frequencies of at least 10 MHz. The noise detector can provide a noise signal which is proportional to the noise and which can optionally be used in addition to a power signal of a photodetector as an input signal of regulation of the control device. The control device can for example control the resonator length via the regulation in such a way that the noise signal is reduced, and the power signal is increased.

In one embodiment, the at least one parameter includes a weighted difference of a noise and a power of that of the converted laser beam. The weighted difference can serve as an input signal for the control device, in particular for regulation of the control device.

In principle, a weighted difference of two arbitrary parameters can be used for the control device as a combined input signal Uᵢ. The combined input signal in the form of a weighted difference can be shown as

$${U}_{i} = {w}_{p} \cdot {U}_{p} - {w}_{HF} \cdot {U}_{HF}$$

wherein U_{P} can represent a voltage signal which is proportional to the measured power P, and can represent U_{HF} a voltage signal that is proportional to the measured noise R. The combined input signal can be used instead of each of the other voltage/input signals. The signals can each be output from a power detector, such as a photodetector, or from a noise detector. The noise detector can be an HF noise detector.

The factors w_{P} and w_{HF} can be weighting factors. The influence of the HF signal U_{HF} on the control behavior of the control device can be controlled via the weighting factor w_{HF}. An advantage of the combined input signal can be that the control device can control the laser resonator, in the case of rapid changes in the ambient conditions, in such a way that the laser resonator is quickly adjusted again, in that the two-mode operation is re-established. This is because in the case of rapid changes in the ambient conditions, optionally initial oscillations of additional laser modes can occur, which can in particular endanger a stable two-mode operation, because they can lead to inadmissible noise values >R_{crit}.

In one embodiment, the control device is configured and provided for adjusting the resonator length and the first attenuation profile on the basis of a change direction of the at least one ambient condition when the at least one parameter has exceeded a predetermined value. For example, an inadmissible noise value R_{crit} can be caused by changing air pressure. The resonator length and the first attenuation profile can then be adapted on the basis of the air pressure having increased or reduced.

In one embodiment, the at least one ambient condition includes an amplitude of vibrations to which the laser arrangement is exposed, and/or an ambient air pressure. For example, the measuring device can measure a first ambient condition which relates to an amplitude of vibrations, and/or can measure a second ambient condition that relates to an ambient air pressure.

The ambient air pressure can change in a short time by up to 100 mbar, for example on account of extreme weather phenomena. The laser resonator can be connected to the ambient air pressure. Therefore, in such cases, the (optical) resonator length changes together with the ambient air pressure. After the change, the laser resonator can deviate from an optimal setting for the two-mode operation. In particular, additional modes can start to oscillate, which lead to undesired noise.

In the case of a change in the ambient air pressure with moderate speed, the change in the ambient air pressure can be compensated by corresponding adjustment of the laser arrangement by the control device. However, if the pressure change takes place too quickly, the control device may sometimes not follow sufficiently quickly, and the frequency-converted laser beam may begin to create noise.

In general, significant shocks can be a cause of stability problems. Significant shocks can in particular occur during transport of the laser arrangement, upon installation, or upon maintenance of the laser arrangement. Such shocks can slightly change the position of optical elements, in particular the resonator mirror and the laser medium, in the laser resonator, and thus change the resonator length or the relative adjustment of the elements with respect to one another, which can lead to the occurrence of undesired secondary modes and thus additional noise.

Shocks and vibrations can also occur, during operation of the laser system, for a limited time period, if for example maintenance, repair or renovation work is carried out in the surroundings of the system. These can result in the at least one parameter, in particular an input signal of the control device, being superimposed by interference. This interference is in principle interpreted by the control device as a deviation that is to be eliminated, and leads to undesired reactions which may possibly lead the laser resonator out of a predetermined operating state, in particular the two-mode operation, and even after the vibrations have abated may ultimately lead to permanent noise which can possibly be overcome only with difficulty by the control device.

Vibrations can above all increase a noise of the frequency-converted laser beam and/or reduce the power. In general, vibrations are merely temporary. The amplitude of vibrations can for example be measured using an acceleration sensor of the measuring device. The control device can be configured and provided for suspending the adaptation of the resonator length and the first attenuation profile hen the amplitude of vibrations exceeds a predetermined value, in order to prevent an undesired adaptation. The suspension while vibrations act on the laser arrangement can prevent a malfunction of the regulation caused by vibrations.

In one embodiment, the control device is configured and provided to specify initial values for control variables for setting the resonator length, the first attenuation profile and/or the second attenuation profile, depending on the ambient air pressure, when the laser arrangement is switched on. For measuring the ambient air pressure, the measuring device can comprise an air pressure sensor.

The initial values can be predetermined such that the control device is capable of operating the laser resonator with exactly two longitudinal modes, and to maintain this state in the long term.

Specifying initial values depending on the ambient air pressure makes it possible, for example, for the air pressure difference between the manufacturing site of the laser, where the initial values are predetermined, and a different site of use, to be compensated. If a first location for operation is for example approximately at sea level, and a second location for operation is 3000 m above sea level, then the air pressure difference is over 300 mbar. The settings of the laser arrangement, in particular of the laser resonator, optimized at the first location for sea level, are then possibly no longer optimal at the second location. Under some circumstances, the settings may be so far from the optimal value that the control device is not capable, proceeding from this, to establish optimal operation, in particular two-mode operation. It may therefore be advantageous to specify the initial values depending on the ambient air pressure.

The object is achieved according to a second aspect of the solution by a method for starting up a laser arrangement having features as described herein.

The method comprises the following steps: switching on the laser arrangement, measuring an ambient air pressure, determining a difference between the measured ambient air pressure and a stored ambient air pressure, varying the temperature of a laser resonator of the laser arrangement over a predetermined temperature range if the difference is greater than a predetermined value, plotting the parameters of a noise and a power of the converted laser beam over the temperature range, selecting a set of temperature intervals having a predetermined minimum spread within the temperature range, in which the noise is below a predetermined value, selecting a temperature interval, from the set of temperature intervals, which fulfils at least one criterion relating to a position of a maximum value of the power in the temperature interval, and specifying an initial value of the temperature of the laser resonator to the position of a maximum value of the power in the selected temperature interval.

The method can allow for starting of a laser arrangement with an air pressure sensor also in the case of an unfavorable initial value for the temperature (for the ambient air pressure), in the case of which a control device of the laser arrangement (optionally with electronic regulation) is not capable of establishing low-noise two-mode operation.

Specifically, upon starting of the system the unfavorable initial values for the temperature can be specified again by the method, such that the control device merely has to maintain a low-noise operation. Upon startup of the laser arrangement, the control device can evaluate an air pressure of the surroundings determined by the air pressure sensor, and compare the value with the stored air pressure value. The control device can comprise a memory for a series of stored ambient air pressure values and possibly associated temperature values for a laser resonator temperature. For example, an ambient air pressure can be stored, which prevailed during an adjustment of the laser arrangement. The difference can for example be greater than a predetermined value of approximately 100 mbar.

In such a case of the difference being greater than a predetermined value, the control device performs a scan of a temperature of the laser resonator. In this case, a control on the basis of the at least one parameter or the at least one ambient condition generally does not take place (regulation deactivated). In this case, the resonator temperature can be changed (scanned) with an increment of approximately 0.1 to 0.2 K, over a temperature range. For each step, an input signal of a measured converted power (i.e. behind the at least one external resonator, in the propagation direction), and a noise, in particular an input signal of a measured amplitude noise (behind the at least one external resonator in the propagation direction) can be plotted.

From the plotted power and the plotted noise, the control device can determine an optimal initial value for the resonator temperature, as follows.

First, temperature ranges can be determined, in which the noise is continuously below a predetermined value. From these, it is possible to select those temperature ranges of which the temperature spread is above a predetermined minimum spread.

These temperature ranges can be noted, as possible working ranges, as the first column in a function matrix. Measured values of the converted power can now be evaluated for each of these temperature ranges. For this purpose, a) a signal stroke (maximum value minus minimum value) of the power, and/or b) a distance of the maximum value of the power (in the temperature) from the edges of the temperature range (center temperature) can be calculated. A center of deviation of the maximum value can be calculated, from the ratio of the distance to the spread of the temperature range in which the maximum value was analyzed, as a measure for a symmetry of a signal curve of the power. The calculated values, above all the center signal stroke and center of deviation, can be noted, for each temperature range, as additional columns in the function matrix. For the center of deviation and the signal stroke, defined threshold values can be predetermined, which have to be reached or maintained. If a plurality of temperature ranges fulfils a plurality of criteria to a comparable extent, weighting factors for the signal stroke, the center of deviation, and the center temperature can be used for an evaluation, in order to select a preferred working range from the matrix and thus an initial value for the temperature of the laser resonator.

After determining the optimal initial value for the resonator temperature, the electronic regulation, possibly deactivated for performing the method steps, can be activated again by the control device, in order to ensure a long-term stable operation, in particular two-mode operation.

### BRIEF DESCRIPTION OF THE DRAWINGS

The concept on which the solution is based will be explained in greater detail in the following with reference to the embodiments shown in the drawings.

FIG. 1 is a schematic view of a laser arrangement.

FIG. 2 is a schematic view of a frequency-dependency of different elements of a laser arrangement.

FIG. 3 schematically shows a power and a mode structure over a temperature for an embodiment according to FIG. 1.

FIG. 4 is a schematic view of a laser arrangement comprising a coated and tilted laser medium.

FIG. 5 is a schematic view of attenuation profiles of a laser arrangement that are adjusted to one another.

FIG. 6 is a schematic view of attenuation profiles of a laser arrangement that are not adjusted to one another.

FIG. 7 schematically shows a power and a mode structure over a temperature for an embodiment according to FIG. 4.

FIG. 8 is a schematic view of a laser arrangement comprising a noise detector.

FIG. 9 is a schematic view of a laser arrangement comprising an air pressure sensor and an acceleration sensor.

FIG. 10 schematically shows curves of the power and of the amplitude noise over the resonator temperature.

FIG. 11 schematically shows curves of the population inversion over a propagation distance of laser modes.

### DETAILED DESCRIPTION

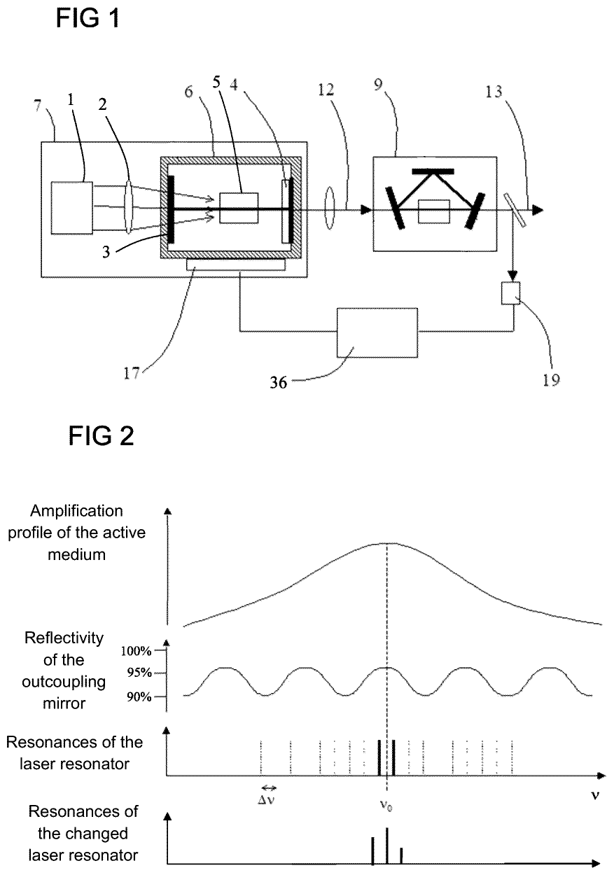

FIG. 1 is a schematic view of a laser arrangement comprising a two-mode laser and an external resonator 9. The two-mode laser 7 comprises a laser diode 1 as a pumped light source emitting a pumped light beam, optional focusing optics 2, which is shown by way of example as a single lens, and a laser resonator 6 having a laser medium 5 arranged approximately centrally therein, a coupling mirror 3 for coupling in the pumped light beam, and an outcoupling mirror 4 for outcoupling laser light, in particular of two laser modes.

The generation of a primary laser beam 12 by coupling the two laser modes out of the laser resonator 6 by the outcoupling mirror 4, and the generation of a frequency-doubled secondary laser beam 13 by the external resonator 9 with its optical elements 9a, 9b, 9c was already described in paragraphs 69 to 71 of DE 103 39 210 B4, which are incorporated at this point by reference.

Furthermore, the laser arrangement comprises a control device 36 and a power detector 19 that is coupled to the control device 36. The control device 36 can for example comprise electronic regulation. The power detector detects a power P of the secondary laser beam 13.

An actuator 17 is provided for controlling a temperature of the laser resonator 6. The actuator 17 can be actuated by the control device 36. The control device 36 is configured and provided for adjusting the resonator length by changing the temperature, on the basis of the power P.

The control device 36 can compensate external influences such as changing ambient conditions, in order to ensure a lasting, low-noise two-mode operation. In the case of the control device 36, use is made of the fact that a power of the frequency-converted radiation 13 generated in the external resonator 9 assumes a maximum when two laser modes, in particular longitudinal modes, have started to oscillate in the laser resonator 6 and have the same intensity. The power detector 19 detects the power P and delivers an electronic input signal, for example a voltage signal Up, to the control device 36. The control device changes a length of the laser resonator via a temperature Tᵣ of the laser resonator in such a way that the power P of the secondary laser beam 13 is as high as possible, which is equivalent to two-mode operation in the case of a symmetrical distribution of the power over the two modes.

FIG. 2 schematically shows the frequency-dependency of the various elements in the laser resonator 6 over the frequency v. The top curve shows an amplification profile of the laser medium (active medium) 5. The upper middle curve shows a reflectivity of the outcoupling etalon 4 (outcoupling mirror), and the bottom curve shows resonances of the laser resonator 6. The preferred frequencies of the outcoupling etalon 4 are those frequencies at which the reflectivity of the outcoupling etalon 4 is at a maximum, and thus the resonator losses are at a minimum. In order to achieve two-mode operation, a preferred frequency of the outcoupling etalon 4 must approximately correspond to a center frequency v₀ of the amplification profile of the laser medium 5, and the frequencies of two neighboring laser modes according to the lower middle curve must be approximately symmetrical to vo. In the case of too great a deviation of the preferred frequency of the outcoupling etalon 4 from the center frequency v₀ of the amplification profile, additional laser modes start to oscillate, which is shown in the bottom curve, in which three laser modes in the case of three different frequencies are shown. Thus, when the optical length of the laser resonator 5 changes, the resonant frequencies of the laser resonator 5 shift relative to the frequencies preferred by the outcoupling mirror 4, as a result of which three laser modes can start to oscillate simultaneously. The frequency spacing between neighboring laser modes is specified as Av.

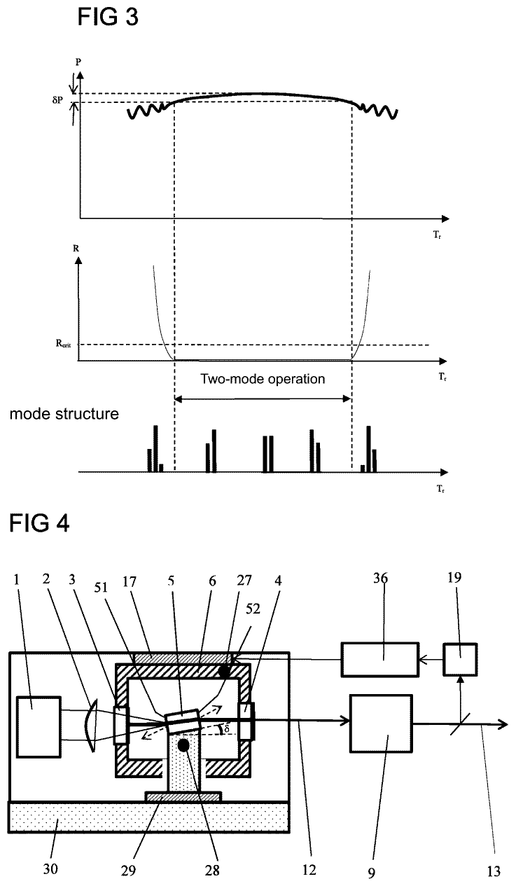

FIG. 3 shows a power P, a noise R, and a mode structure of the secondary laser beam 13 over the temperature Tᵣ of the laser resonator 5. When two laser modes in the laser resonator have the same intensity, the power P of the frequency-converted secondary laser beam 13 generated in the external resonator 9 assumes a maximum. Outside of the region in which two laser modes start to oscillate in the laser resonator 5 (two-mode operation), an addition third mode starts to oscillate. A difference of the power between a center and an edge of the region of the two-mode operation is given as 6P. The amplitude noise R of the secondary laser beam increases significantly outside of the two-mode operation. Outside of the two-mode operation, the fluctuations of the power signal P also increase. A predetermined, critical value for the noise R_{crit}, which should not be exceeded, is already reached shortly after leaving the two-mode operation. The control device should thus prevent, as far as possible, the two-mode operation from being left, in order to achieve low noise and high power. In other words, it is desirable for the control device to ensure that the laser arrangement is operated with exactly two laser modes.

FIG. 4 is a schematic view of a laser arrangement comprising a laser medium 5 which comprises two parallel surfaces 51, 52 which are provided with a partially reflective coating in each case, the reflectivity of which is between 0.2% and 2.0%, in particular between 0.4% and 0.8%, and the normals of which are arranged at an angle δ obliquely to a propagation direction of the two laser modes. The angle δ is between 1° and 6°. Essential components of the laser arrangement correspond to the components of the laser arrangement which has been described in connection with FIG. 1, and are provided with identical reference signs.

The coatings on the surfaces 51, 52 ensure a certain minimum reflectivity Rₘᵢₙ and maximum reflectivity Rₘₐₓ in the fundamental frequency of the two laser modes. Such coatings can be applied to the surfaces 51, 52 by means of an ion beam sputtering (IBS) method. A preferred reflectivity range is e.g. between Rₘᵢₙ=0.4% and Rₘₐₓ=0.8%, inclusive.

The laser medium 5 is furthermore tilted about an angle δ (1°<δ<6°) relative to a propagation direction of the two laser modes. This corresponds to tilting relative to an axis of the laser resonator 6. The tilting prevents formation of sub-resonators between the optical surfaces of the laser medium and the resonator mirrors 3, 4. Such sub-resonators can lead to disturbances of the two-mode operation. The laser medium is thus configured and provided for allowing a frequency-dependent modulation of losses internal to the resonator, which is equivalent to the effect of what is known as a “tilted etalon”.

FIG. 5 shows a comparison of a plurality of curves 41, 42, 43, 44 over a frequency of the two laser modes. The curves are explained in detail in the following.

The curve 41 describes the relative losses V (in percent of a total power of the two laser modes) as a function of the frequency which is generated by the outcoupling mirror 4. Thus, the curve 41 is an example for an attenuation profile of the second resonator mirror (first attenuation profile). A frequency spacing of the minima of the curve 41 Δvₐ is determined as follows, over an optical length nₐ*Lₐ of the outcoupling mirror 4:

$$Δ {v}_{a} = \frac{c}{2 {n}_{a} {L}_{a}}$$

The curve 42 describes the relative losses V (in percent of a total power of the two laser modes) as a function of the frequency of the two laser modes, of what is known as a fundamental wave frequency, which is generated by the laser medium 5 in the laser resonator 6. Thus, the curve 42 is an example for an attenuation profile of the laser mediums (second attenuation profile). A frequency spacing Δvₓ of the minima of the curve 42 is determined as follows, by an optical length nₐ*Lₐ of the laser medium:

$$Δ {v}_{x} = \frac{c}{2 {n}_{x} {L}_{x}}$$

Herein, nₓ is the refractive index, Lₓ a length of the laser medium 5, and c the speed of light. A maximum loss in the maxima is determined by the reflectivity of the (optical) surfaces of the laser medium. An increased reflectivity provided by the coatings on the one hand reduces the power of the two laser modes, but on the other hand increases the frequency-selecting effect of the laser medium 5.

The curve 43 describes the relative losses V produced in total by the laser medium 5 and the outcoupling mirror 4. The smaller a value of the sum of the curves 41, 42 in the curve 43, the higher the power that the two laser modes can achieve.

In the case of a favorable selection of the length ratios of Lₓ and Lₐ and the reflectivity of the surfaces 51, 52 of the laser medium, the frequency selectivity of the total loss curve 43 is increased, without the power of the two modes being noticeably reduced. In the example shown:

$$\frac{Δ {v}_{a}}{Δ {v}_{x}} = \frac{{n}_{x} {L}_{x}}{{n}_{a} {L}_{a}} ≅ 3$$

and the reflectivity R≅0.6%. The minima of the relative losses at the outcoupling mirror 4 thus have a frequency spacing Δvₐ from one another that is many times larger the frequency spacing Δvₓ of the minima of the relative losses at the laser medium 5.

The curve 44 describes a quality Q of the laser resonator 6 as a function of the frequency, wherein a variability of the resonator losses is not taken into account. It can be seen that only mutually spaced, discrete laser modes can be caused to start oscillating in the laser resonator. The laser modes that can be caused to start oscillating are located at the resonant frequencies of the laser resonator.

Spacings Δv_{R} of the resonant frequencies of the individual laser modes are given by

$$Δ {v}_{R} = \frac{c}{2 {L}_{Ropt}}$$

wherein L_{Ropt} is the optical length of the laser resonator 6 which is made up of the following parts:

$${L}_{Ropt} = {n}_{L} {L}_{R} + ( {n}_{x} - {n}_{L} ) {L}_{x} + ( {n}_{a} - {n}_{L} ) {L}_{a}$$

wherein L_{R} is the laser resonator length, i.e. the distance from the coupling mirror to the outcoupling mirror, and n_{L} is a refractive index of an interior of the laser resonator 6 which is for example determined by a gas mixture located therein or by the air that is present.

The laser resonator length LR is generally significantly greater than the other parts, such that L_{R} has the greatest influence on the frequency of the possible laser modes.

The laser modes indicated by arrows are active laser modes which, in the curve 44 shown by way of example, are preferably actively caused to start oscillating. This is because they are closest to the minimum of the total loss curve. In contrast to the two laser modes that can be caused to start oscillating, the other possible laser modes of the laser resonator are subject to greater losses. If two laser modes have once started oscillating in the laser resonator, no further amplification remains for other laser mode. This results in a self-stabilizing system of two laser modes.

A position of the minima of the relative losses V which are generated by the laser medium 5 and the outcoupling mirror 4, in curves 41 and 42 with respect to one another and with respect to the possible laser modes of the laser resonator, depends sensitively on a length of different frequency-selective elements of the laser resonator, and above all on the length of the outcoupling mirror 4 and laser medium 5. In order for the frequency selectivity of the total loss curve 43 for the desired two neighboring laser modes, which are active (arrows on curve 44), to be optimal, the curves 41, 42 and 44 must be synchronized with one another. Synchronization of the curves 41, 42 and 44 includes in particular an adaptation of a length of the laser resonator 6 (effect on curve 44), a length of the outcoupling mirror 4 (effect on curve 41), and a length of the laser medium 5 (effect on curve 42).

In order to adapt the mentioned three lengths, the laser arrangement according to the embodiment shown in FIG. 4 comprises a control device 36 which is configured and provided for setting a temperature Tᵣ of the laser resonator 6 via a first actuator 17 and/or for setting a temperature Tₓ of the laser medium 5 via a second actuator 29, in order to change the first and the second attenuation profile, in particular to adjust them to one another. The temperature Tₓ of the laser medium 5 can be set independently of the temperature Tᵣ of the laser resonator 6. A temperature sensor 27 is provided on the laser resonator 6 for measuring the temperature Tᵣ, and is coupled to the control device 36. Furthermore, a temperature sensor 28 is provided on the laser medium 5 for measuring the temperature Tₓ, and is coupled to the control device 36.

The temperature regulation of the laser medium 5 is configured and provided to operate largely independently of a temperature regulation of the laser resonator 6. This is achieved by preventing thermal bridges between the laser resonator 6 and the laser medium 5. Preferably Peltier elements are used for the actuators 17 and 29, which Peltier elements are thermally linked to a common heat sink 30.

In the case of a change in the resonator temperature Tᵣ, the laser modes that can be caused to start oscillating undergo a frequency shift, i.e. the maxima of the resonator modes in curve 44 change, since the resonator length changes on account of the temperature expansion. The outcoupling mirror 4 is thermally connected to the laser resonator 6. Therefore, with Tᵣ the minima of the curve 41 assigned to the outcoupling mirror 4 also shift. However, the shift has a substantially lower rate than the shift of the laser modes that can be caused to start oscillating. A rate of shift of the curve 41 is determined not only by a thickness Lₐ (i.e. a length along the propagation direction of the laser mode) of the outcoupling mirror 4, but rather also by a temperature coefficient of the refractive index nₐ of the material of which the outcoupling mirror 4 consists.

Thus, changing the resonator temperature Tᵣ allows for the curve 44 and curve 41 to shift relative to one another, such that the minimum of the curve 41 is positioned symmetrically to two selected laser modes, which can be caused to start oscillating, of the laser resonator 6. Changing the temperature Tₓ of the laser medium 5 results in a shift of substantially only the curve 42. Therefore, appropriately setting the temperature Tₓ allows the curve 42 to be synchronized by the curves 44 and 41. The synchronization comprises adjusting the second attenuation profile (curve 42) to the first attenuation profile (curve 41).

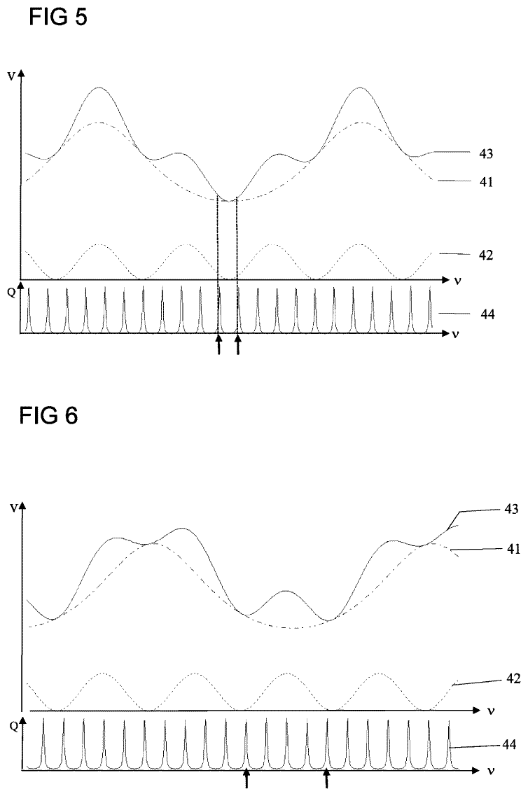

In FIG. 5, the temperatures of the laser resonator 6 and of the laser medium 5 are optimally adjusted to one another, such that in each case a minimum of the curves 41 and 42 are located above one another and symmetrically with respect to two laser modes which can be caused to start oscillating and which were selected for initial oscillation. FIG. 6 shows a situation in which the temperatures are not adjusted to one another. In this case, laser modes, spaced apart from one another by at least one laser mode that can be caused to start oscillating, can be caused to start oscillating, such that stable two-mode operation is not possible (cf. the two vertical arrows which indicate, in curve 44, two laser modes separated by three laser modes which can be caused to start oscillating).

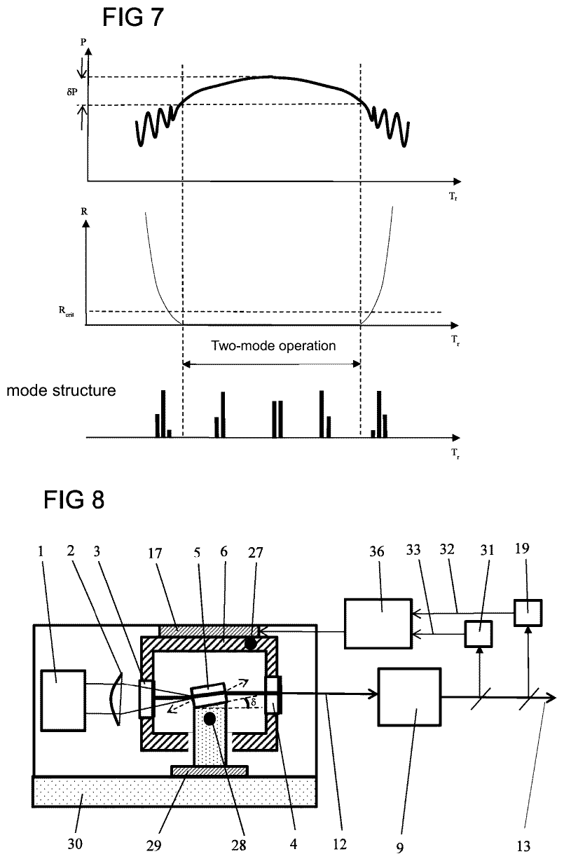

FIG. 7 shows the power P of the frequency-converted secondary laser beam 13 generated in the external resonator 9 of the embodiment according to FIG. 4. The illustration largely corresponds to the illustration in FIG. 3. However, the maximum of the power P is significantly more pronounced, in contrast with the curve in FIG. 3. The difference of the power between a center and an edge of the region of the two-mode operation 6P is significantly greater. The greater variation of the power P over the resonator temperature Tᵣ can be traced back to the coating and the oblique position of the laser medium 5. The etalon effect caused by this allows for a higher frequency selectivity.

In the embodiment according to FIG. 4, the difference δP of the power P between the center and the edge of the two-mode operation is approximately 10 times greater than according to FIG. 3. As a result the signal-to-noise ratio of the input signal for the control device 36 in FIG. 4 is improved by approximately a factor of 10, as a result of which the regulation can react more reliably and faster to rapid changes in the ambient conditions.

In the case of the laser arrangement according to FIG. 4, the laser medium 5 is doped. An accuracy with which the doping level is specified can be within the limits of plus/minus 0.05% (inclusive). In this embodiment, the configuration of the laser medium 5 as an etalon, and the more precise specification of the doping level, was able to increase the average tolerance range of the resonator temperature Tᵣ to values of greater than or equal to 1 K, as a result of which it was possible to significantly increase the stability of the two-mode operation.

FIG. 8 shows a further embodiment. The illustration largely corresponds to the illustration in FIG. 4, wherein identical components have identical reference signs. In contrast to the embodiment according to FIG. 4, in the embodiment according to FIG. 8 a noise detector 31 is additionally provided. The noise detector 31 provides the control device 36 with a second input signal 33 in addition to a first input signal 32 from the power detector 19.

The noise detector is provided and configured for measuring noise amplitudes of the secondary laser beam 13 having frequencies of at least 10 MHz, preferably up to 100 MHz or more, and for outputting a DC voltage signal U_{HF} that is proportional to the noise amplitude. This can be implemented for example with the aid of a fast photodiode and a following true RMS HF detector. Such true RMS HF detectors are available as integrated components.

The control device can have an expanded control strategy which, in addition to the first input signal 32 of the power detector 19, also takes into account the second input signal 33 of the noise detector. The control device is configured and provided, in the case of low noise amplitudes, to maximize the power of the secondary laser beam 13 by slow changes of the resonator temperature Tᵣ. In this case, the control variable Tᵣ is modulated with a very low frequency (<0.1 Hz), and the resulting changes in the power P of the secondary laser beam 13 are demonstrated in a phase-sensitive manner. From this, it is then possible to calculate a direction (plus/minus) and an amount of the correction for the control variable Tᵣ. In this case, the control parameters are set such that no oscillations occur and the signal noise, always present, does not cause any abrupt changes to the control variable.

Outside of the two-mode operation, the measured power 32 loses significance, because it undergoes increasing fluctuations. At the same time, however, the HF noise amplitude increases continuously. In this region, the behavior of the regulation is determined increasingly by the noise amplitude.

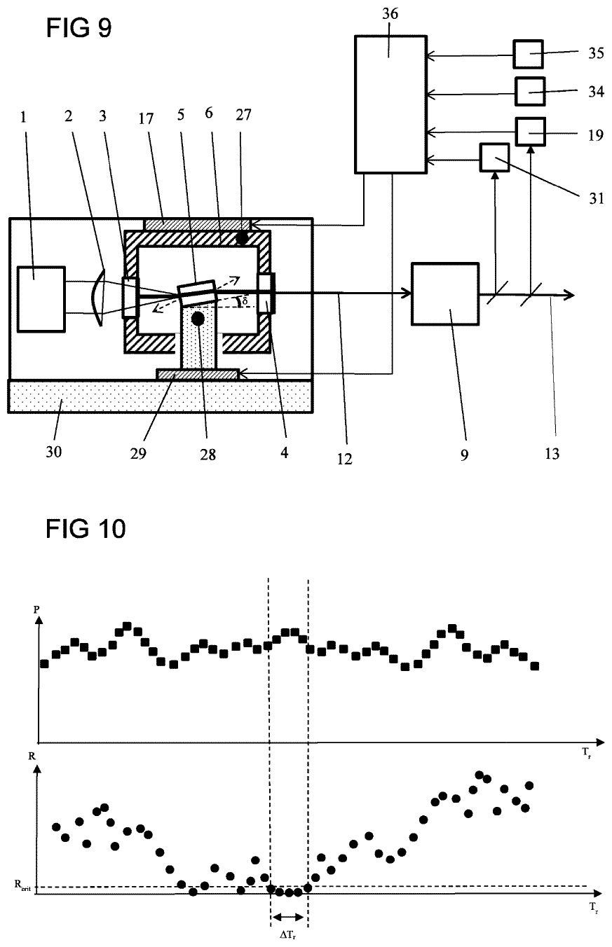

FIG. 9 shows a further embodiment. The illustration largely corresponds to the illustration in FIG. 8, wherein identical components have identical reference signs. In contrast to the embodiment according to FIG. 8, in the embodiment according to FIG. 9 an air pressure sensor 34 and an acceleration sensor 35 are additionally provided. The air pressure sensor 34 and the acceleration sensor 35 provide input signals which, just like the input signals of the power detector 19 and of the noise detector 31, are forwarded to the control device 36, which is preferably configured as a microprocessor controller. The actuators 17 and 29 for controlling the resonator temperature or the temperature of the laser medium 5 are actuated by the control device 36.

The air pressure sensor 34 is intended to prevent the laser arrangement starting up operation in the case of such an unfavorable initial setting with regard to resonator temperature and temperature of the laser medium that it is not possible for the control device, with electronic regulation, to establish low-noise two-mode operation on the basis of the first and second input signal 32, 33.

Upon startup of the laser arrangement, the control device 36 reads out the air pressure sensor 34 and compares the value with the stored air pressure value which prevailed at the time of the adjustment of the laser arrangement. If the difference is greater than a critical value of approximately 100 mbar, the control device firstly performs a scan of the resonator temperature. In this case, the resonator temperature is changed with an increment of approximately 0.1 to 0.2 K, over a predetermined range, and the first and second input signal 32, 33 are plotted.

FIG. 10 schematically shows the signals plotted in the case of such a scan. The top curve shows the power of the secondary laser beam 13 over the resonator temperature Tᵣ. The bottom curve shows the noise of the secondary laser beam 13 over the resonator temperature Tᵣ. From these plotted signals, the control device determines the best starting value for the resonator temperature. The best starting value for the resonator temperature is in the region ΔTᵣ, specified by way of example. In this region, the power is locally at a maximum, and the noise is below a predetermined critical value R_{crit}.

The acceleration sensor 35 of the embodiment according to FIG. 9 serves to detect shocks and vibrations during operation of the laser arrangement, which act on the laser arrangement from the outside. If these influences exceed a predetermined critical value, they may interfere with the input signals for the electronic regulation of the resonator temperature or of the temperature of the laser medium in such a way that the regulation is no longer capable of maintaining the two-mode operation. The control device is programmed such that the regulation is suspended for the duration of the vibrations. It then keeps the actuator variables constant, as a result of which the existing state is maintained. If the strength of the vibrations falls below the critical value again, the regulation continues to operate proceeding from the state before the interference. This prevents temporally limited interference due to vibrations from moving the laser arrangement out of the two-mode operation and thereby leading to increased noise.

According to an alternative embodiment to the embodiment according to FIG. 9, a laser arrangement comprises a control device 36 which exclusively uses the input signals of the noise sensor 31 and of the air pressure sensor 34 for the regulation. The signal of the power detector 19 is not used for the regulation.

For regulation by means of the air pressure and the noise, firstly a direction of the air pressure change is determined from the time curve of the input signal of the air pressure sensor 34 over a suitable time period. If the input signal 33 of the noise sensor 31 exceeds a critical threshold, then the resonator temperature Tᵣ is changed, by the control device, by a predetermined value, wherein the direction (increase or decrease) is dependent on the direction of the air pressure change. This process can be repeated until the input signal 33 of the noise sensor 31 is below the critical threshold, i.e. the laser arrangement again operates in a low-noise manner.

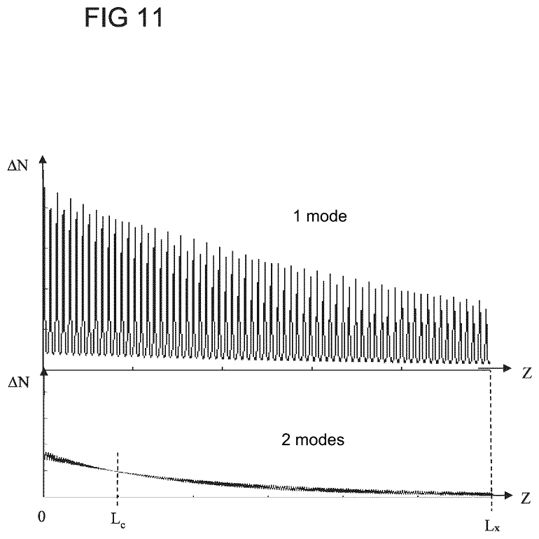

FIG. 11 shows curves which show the spatial modulation of the population inversion by zones of different field strength in the laser medium 5 (“hole-burning effect”) for one laser mode and for two laser modes. The curves are results of a simulation calculation for a population inversion AN in a laser crystal, over a propagation distance of a laser mode Z. An inlet side into the laser medium 5 for the pumped radiation is located at Z=0. The top curve shows the population inversion for the case where only one longitudinal mode is active, and the lower part is for the case where two longitudinal modes are active.

Due to the formation of a standing wave, in the case of just one longitudinal mode a significant modulation of the population inversion is observed, i.e. a significant hole-burning effect. In the case of two longitudinal modes, the modulation of the population inversion is significantly reduced, and disappears completely at the point Z=Z=L_{c}, wherein L_{c} is the point in the crystal which is located in the optical center of the resonator.

Complete suppression of the hole-burning effect by the 90° phase shift of neighboring laser modes, in particular neighboring longitudinal modes, is therefore successful only at one point in the laser resonator 6, specifically in the optical center. The hole-burning effect increases with increasing distance from the optical center. Since the laser medium has a finite extension, an increasing hole-burning effect occurs with increasing extension of the laser medium 6 and thus increasing distance from the optical center. This ensures an amplification of undesired longitudinal modes which increases with distance from the optical center. Therefore, with increasing length of the laser medium in the propagation direction of the laser modes, the risk of secondary modes, which start to oscillate and lead to undesired noise, increases.

In the case of a diode-pumped Nd:YVO₄ laser crystal as the laser medium, an absorption length Lₐ of the laser medium is determined by an absorption coefficient α of the laser medium, at the pumping wavelength. This in turn depends on the doping level of the crystal with neodymium atoms. If the length of the laser crystal Lₓ is greater than the absorption length Lₐ, the length of the laser medium can be approximately equated to the absorption length Lₐ=1/α, since the amplification after this absorption distance no longer makes any substantial contribution. For the stability of the two-mode operation, the ratio η of the optical length of the resonator L_{Ropt} to the optical length of the laser medium nₓ·Lₐ is now decisive:

$$η = \frac{{L}_{Ropt}}{{n}_{x} \cdot {L}_{a}}$$

The smaller this ratio, the smaller the tolerance range for the optical resonator length or the temperature of the resonator for which two-mode operation is possible. For good stability of the laser, it is necessary for a tolerance range for the resonator temperature to be at least 0.5 K. For the ratio η, for example the following can apply:

$$η \geq 13$$

In the production of laser crystals, variances in the doping level sometimes occur, which can lead to this value not being reached. An insufficiently doped laser crystal may cause the absorption length of the laser medium 5 to increase in such an unfavorable manner that an unstable two-mode operation results. Instabilities occur for example in the case of a reduction of the tolerance range for the resonator temperature by the variation of the doping level, to values of below 0.3 K. Conversely, the doping may not be too high, since too high a doping leads to self-absorption of laser modes in a non-pumped portion of the laser medium, and thus the output power reduces. In general, variances of parameters of optical components can be a source for instabilities.

### LIST OF REFERENCE SIGNS

1 pumped light source
2 focusing optics
3 coupling mirror
4 outcoupling mirror
5 laser medium
51, 52 surface
6 laser resonator
7 two-mode laser
9 external resonator
9a, 9b, 9c optical elements
12 primary laser radiation
13 secondary laser radiation
17 actuator
19 power detector
28 temperature sensor
29 actuator
30 heat sink
31 noise detector
32 first input signal
33 second input signal
34 air pressure sensor
35 acceleration sensor
36 control device
41, 42 attenuation profile
43 total loss curve
44 quality curve
δ angle
L_{c} optical center
Lₓ length of the laser medium
ΔN population inversion
Δv frequency spacing
v₀ center frequency
v frequency
P power
ΔP power difference
R noise
R_{crit} noise value
Q quality
Tᵣ resonator temperature
Tᵣ temperature range
V relative losses
Z propagation distance

1. A laser arrangement for generating laser light, comprising
a laser resonator for initial oscillation of two laser modes between a first and a second resonator mirror which are spaced apart from one another by a resonator length, wherein the second resonator mirror is configured and provided for coupling the two laser modes out of the laser resonator, and wherein the second resonator mirror has a first frequency-dependent attenuation profile for laser light,
a laser medium which is arranged between the resonator mirrors,
a measuring device which is configured and provided for measuring at least one parameter of the two out-coupled laser modes and/or at least one ambient condition of the laser arrangement,
a control device which is configured and provided for adjusting the resonator length and the first attenuation profile on the basis of the at least one parameter and/or the at least one ambient condition,
wherein the laser medium has a second frequency-dependent attenuation profile, and the control device is configured and provided to change the first and the second attenuation profile, in particular to adjust them to one another.

2. The laser arrangement according to claim 1, wherein the laser resonator and the second resonator mirror are configured and provided such that exactly two longitudinal laser modes of neighboring frequencies can be outcoupled.

3. The laser arrangement according to claim 1, further comprising at least one external resonator which is configured and provided for receiving the two laser modes from the laser resonator and for converting the frequency of the two laser modes.

4. The laser arrangement according to claim 3, wherein the measuring device is configured and provided for measuring the at least one parameter at the frequency-converted laser beam.

5. The laser arrangement according to claim 1, wherein the control device is configured and provided to adjust the first and the second attenuation profile to the effect that the frequencies of the minima of the attenuation profiles correspond.

6. The laser arrangement according to claim 1, wherein the laser medium comprises two parallel surfaces which are provided with a partially reflective coating in each case.

7. The laser arrangement according to claim 6, wherein the coating is configured and provided to provide a reflectivity that is independent of the ambient conditions.

8. The laser arrangement according to claim 1, wherein the control device is configured and provided for setting a temperature of the laser resonator via a first actuator and/or for setting a temperature of the laser medium via a second actuator, in order to change the first and the second attenuation profile.

9. The laser arrangement according to claim 1, wherein the laser medium comprises a doped laser crystal, the doping level of which is determined such that the ratio of an optical length of the laser resonator to an optical length of the laser medium is greater than 10.

10. The laser arrangement according to claim 1, wherein the at least one parameter includes a noise and/or a power of the two outcoupled laser modes.

11. The laser arrangement according to claim 1, wherein the control device is configured and provided for adjusting the resonator length and the first attenuation profile on the basis of a change direction of the at least one ambient condition when the at least one parameter has exceeded a predetermined value.

12. The laser arrangement according to claim 1, wherein the at least one ambient condition includes an amplitude of vibrations to which the laser arrangement is exposed, and/or an ambient air pressure.

13. The laser arrangement according to claim 12, wherein the control device is configured and provided for suspending the adaptation of the resonator length and the first attenuation profile when the amplitude of vibrations exceeds a predetermined value, in order to prevent an undesired adaptation.

14. The laser arrangement according to claim 12, wherein the control device is configured and provided to specify initial values for control variables for setting the resonator length, the first attenuation profile and/or the second attenuation profile, depending on the ambient air pressure, when the laser arrangement is switched on.

15. A method for starting up a laser arrangement, comprising the following steps:
a. switching on the laser arrangement,
b. measuring an ambient air pressure,
c. determining a difference between the measured ambient air pressure and a stored ambient air pressure,
d. varying the temperature of a laser resonator of the laser arrangement over a predetermined temperature range when the difference is greater than a predetermined value,
e. recording the parameters of a noise and a power of two laser modes coupled out of the laser resonator, over the temperature range,
f. selecting a set of temperature intervals of a predetermined minimum spread within the temperature range, in which the noise is below a predetermined value,
g. selecting a temperature interval from the set of temperature intervals which fulfils at least one criterion relating to a position of a maximum value of the power in the temperature interval, and
h. specifying an initial value of the temperature of the laser resonator to the position of the maximum value of the power in the selected temperature interval.

16. The laser arrangement of claim 6, wherein the reflectivity of the parallel surfaces is between 0.2% and 2.0%, and the normals of the parallel surfaces are arranged at an angle between 1° and 6° obliquely to a propagation direction of the two laser modes.

17. The laser arrangement according to claim 7 wherein the ambient conditions include a moisture content of a gas surrounding the coating.

18. The laser arrangement according to claim 10, wherein the at least one parameter includes a weighted difference between the noise and a power of the two outcoupled laser modes.
